(19) United States
(12) Patent Application Publication
(10) Pub. No.: US 2009/0066850 A1
(43) Pub. Date: Mar. 12, 2009

(54) SMART CHANNEL SCAN METHOD AND ASSOCIATED APPARATUS

(76) Inventor: Shan-Tsung Wu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 12/196,249

(22) Filed: Aug. 21, 2008

(30) Foreign Application Priority Data
Sep. 12, 2007 (TW) 096134097

(51) Int. Cl. H04N 5/50

(52) U.S. Cl. 348/731; 348/E05.097

(57) ABSTRACT

A smart channel scan method and associated apparatus, for searching center frequencies and symbol rates of the video signal channels. The smart channel scan method performs spectrum analysis for the video signal to generate a power spectrum density signal and obtain a plurality of center frequencies and coarse bandwidth. Symbol rates are determined according to the power spectrum density signal and the coarse bandwidth.

### BACKGROUND OF THE INVENTION

1. Field of the Invention

The present invention relates to channel scanning, and particularly relates to a smart channel scan apparatus for searching center frequencies and symbol rates of a video signal and related method thereof.

2. Description of the Prior Art

FIG. 1 illustrates a video signal 100 in the frequency domain, which includes a plurality of signal bands 101, 103 and 105 respectively having center frequencies f_{c1}, f_{c2}, f_{c3} and bandwidths f_{b1}, f_{b2} and f_{b3}. Thus, if video images are to be retrieved, correct center frequencies f_{c1}, f_{c2}, f_{c3} and bandwidths f_{b1}, f_{b2} and f_{b3} should be obtained first.

Conventionally, correct center frequencies and bandwidths of a DVB (digital video broadcasting) signal transmitted from a satellite are searched by a tuner. In this case, correct center frequencies and bandwidths of each signal band are guessed step by step and then transmitted to the backend demodulator for further processing. Since center frequencies and bandwidths vary corresponding to different DVB channels, such a method of utilizing a scan to search is slow. Persons skilled in the art can easily understand that the center frequencies and bandwidths of various broadcasting channels will generate a plurality of arrangements, which will require a lot of computing effort, thereby the accuracy also decreases. A conventional DVB tuner needs more than 40 minutes to search out complete center frequencies and bandwidths, and the burden of the backend circuit is high.

### SUMMARY OF THE INVENTION

One objective of the present invention is to provide a smart channel scan method and related apparatus thereof, to rapidly obtain center frequencies and accurate symbol rates.

The present invention discloses a smart channel scan method, comprising: receiving a video signal; spectrum-analyzing the video signal to generate a center frequency and a coarse bandwidth; processing the video signal according to the coarse bandwidth to generate a power spectrum density signal; and obtaining an accurate symbol rate according to the coarse bandwidth and the power spectrum density signal.

The present invention also discloses a smart channel scan apparatus comprising a center frequency and coarse bandwidth generating circuit and an accurate symbol rate generating circuit. The center frequency and coarse bandwidth generating circuit spectrum-analyzes a video signal to generate a center frequency and a coarse bandwidth. The accurate symbol rate generating circuit, coupled to the center frequency and coarse bandwidth generating circuit, receives the video signal to detect an accurate symbol rate.

The above-mentioned method and circuit structures not only can obtain correct center frequencies and accurate symbol rates, but also have low error rates, which is good for operation of the back end circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a video signal in the frequency domain.

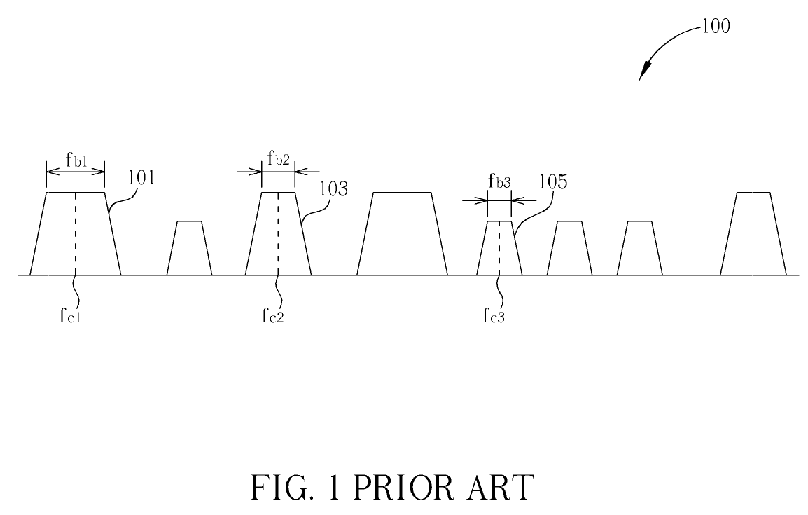

FIG. 2 is a flow chart of a smart channel scan method according to a preferred embodiment of the present invention.

FIG. 3 is a schematic diagram illustrating the spectrum analyzing.

FIG. 4 illustrates a difference signal diagram for obtaining the center frequency and the coarse bandwidth.

FIG. 5 is a schematic diagram illustrating multiplying the spectrum signal with the difference signal.

FIG. 6 is a schematic diagram illustrating a spectrum with coarse bandwidth detection.

FIG. 7 is a schematic diagram illustrating another spectrum with coarse bandwidth detection.

FIG. 8 illustrates a method for generating accurate symbol rates according to one preferred embodiment of the present invention.

FIG. 9 is a power spectrum density diagram.

FIG. 10 is a smart channel scan apparatus according to a preferred embodiment of the present invention.

FIG. 11 is a circuit diagram for detecting a center frequency and coarse bandwidth according to a preferred embodiment of the present invention.

FIG. 12 is a circuit for generating accurate symbol rates according to a preferred embodiment of the present invention.

FIG. 13 is a smart channel scan digital TV demodulation apparatus according to a preferred embodiment of the present invention.

FIG. 14 is a flow chart illustrating a smart channel scan method according to a preferred embodiment of the present invention.

### DETAILED DESCRIPTION

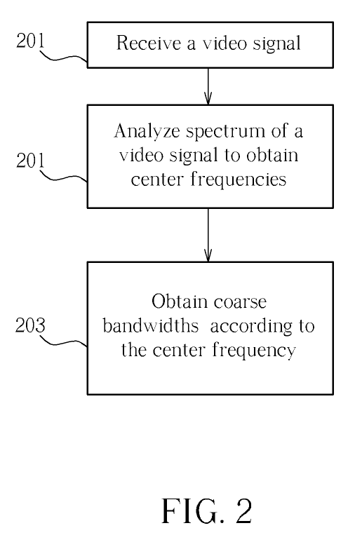

FIG. 2 is a flow chart of a smart channel scan method according to a preferred embodiment of the present invention. Beginning at step 201, a video signal is received. At step 202, analyze a spectrum of the video signal to obtain center frequencies of a plurality of bands. At step 203, obtain coarse bandwidths associated with each center frequency according to the center frequencies. Preferably, the video signal can be a digital video broadcasting signal, which can be converted to a digital signal utilizing an analog to digital converter, and performs a Fourier transform to spectrum-analyze the video signal.

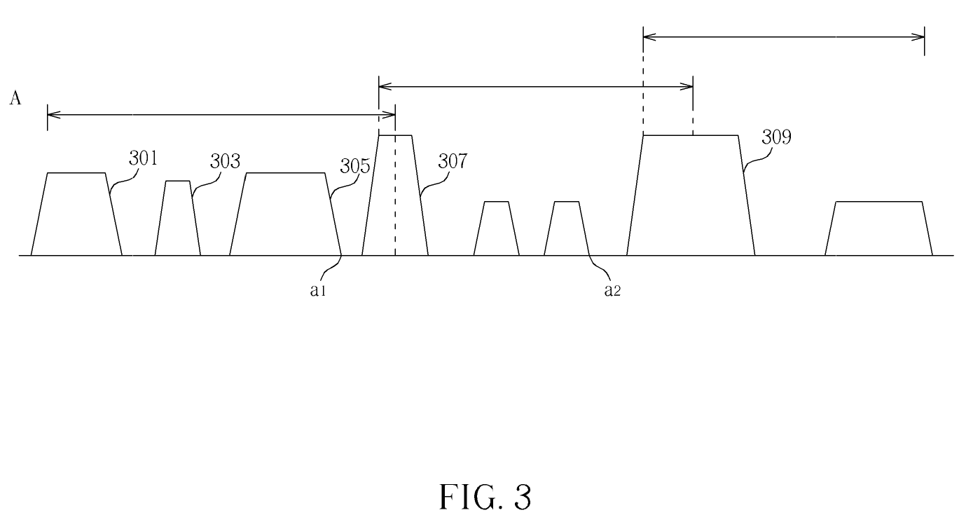

FIG. 3 is a schematic diagram illustrating the spectrum analyzing step 202 shown in FIG. 2. For example, a Welch-Bartlett scan can be applied. If the first scan can complete signal bands 301, 303 and 305 and an incomplete signal band 307, then the second scan preferably begins at the point a₁, which is the end of the complete signal band 307. Similarly, if the second scan includes an incomplete signal band 309, then the third scan preferably begins at the point a₂, which is the end of the complete band signal 309. Each band is spectrum-analyzed to obtain a center frequency. In this embodiment, the center frequencies possess an error less than 1% and a bandwidth error less than 3%.

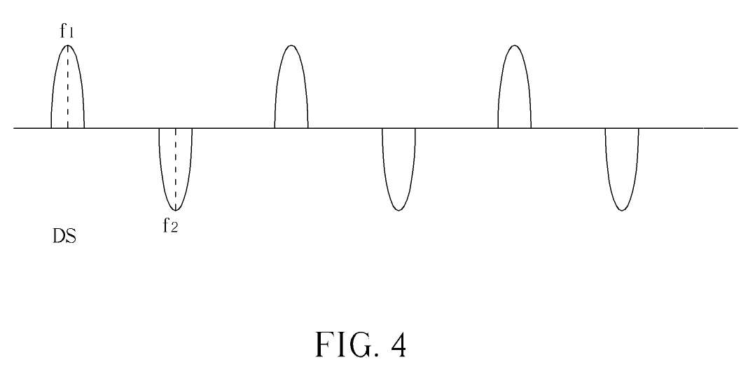

FIG. 4 illustrates a difference signal diagram for obtaining the center frequency and the coarse bandwidth. A delayed power spectrum density signal is subtracted from the power spectrum density signal obtained in the above embodiment to obtain a difference signal DS. A frequency value f₁ associated with a maximum vale and a frequency value f₂ associated with a neighboring minimum are averaged to generate an average value

$$( \frac{{f}_{1} + {f}_{2}}{2} )$$

as the center frequency. A difference of the frequency value f₁ and the frequency value f₂ is calculated to obtain a coarse bandwidth (f₁-f₂).

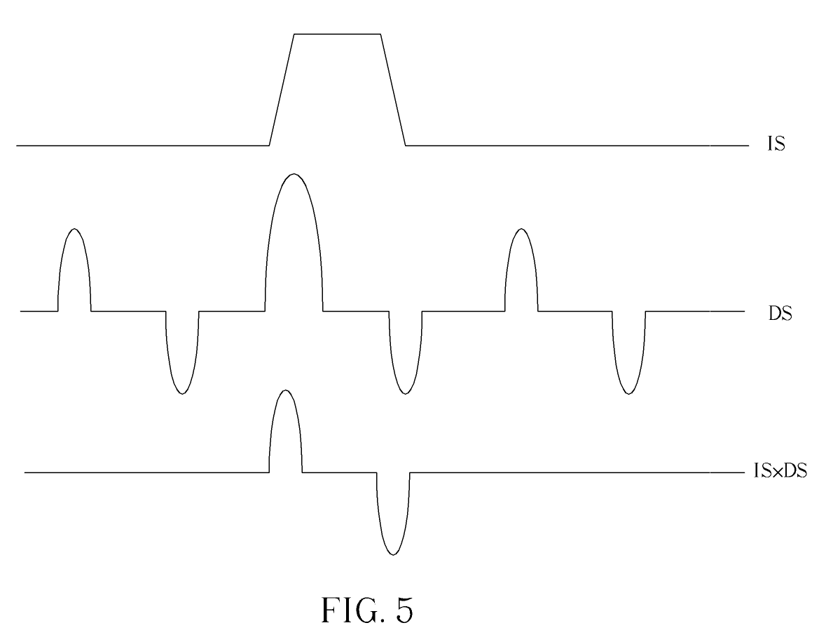

FIG. 5 is a schematic diagram illustrating multiplying the spectrum signal IS with the difference signal DS to filter unwanted signal. During the process of producing the difference signal DS in FIG. 4, even a small amount of noise will cause apparent up-protruding or down-protruding waves on the difference signal DS. In this embodiment, assume the original video signal spectrum IS includes a signal band. The noise output on the difference signal DS can be suppressed after the original video signal spectrum IS is multiplied with the difference signal DS. In this way, the correct spectrum difference signal corresponding to the original video signal spectrum IS can be accurately obtained.

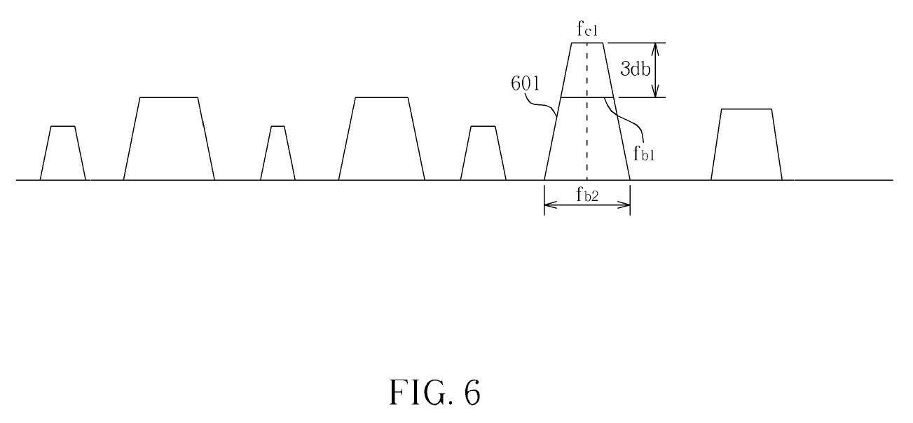

FIG. 6 is a spectrum with the coarse bandwidth detection shown in FIG. 2. If a center frequency of the signal band 601 is detected as f_{c1}, than it is detected whether an amplitude of the signal band 601 decreases for 3 db. If the signal band already decreases for 3 db, the bandwidth f_{b1} with 3 db decrease is determined as the coarse bandwidth of the signal band 601.

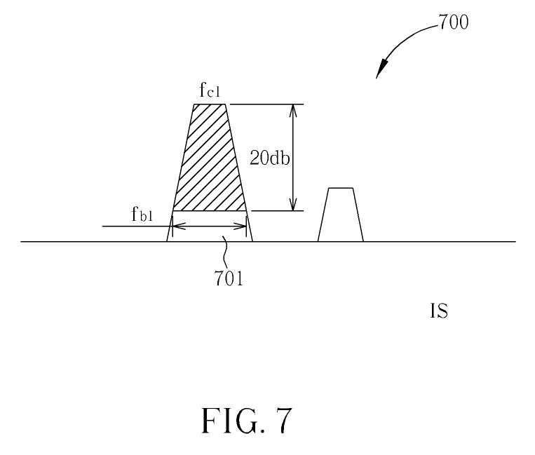

FIG. 7 is a schematic diagram illustrating another spectrum with the coarse bandwidth detection shown in FIG. 2, which detects whether the signal band decreases for a predetermined area. That is, it is detected whether the signal band decreases for a predetermined energy. Assume the coarse center frequency of the signal band 701 positions at the maximum point of the spectrum, then a horizontal line is applied to horizontally cut the spectrum, and the decreased energy represented by the shaded area is calculated. If the decreased energy reaches 20 db, then the corresponding bandwidth f_{b1} is determined as the coarse bandwidth of the signal band 701. The average value of the two frequencies at which the horizontal cut line intersects the spectrum is calculated and utilized as the accurate center frequency f_{c1} of the signal band 701.

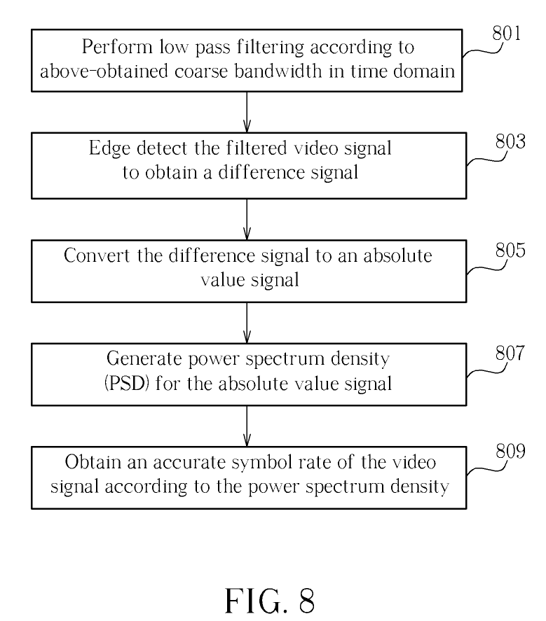

FIG. 8 illustrates a method for generating accurate symbol rates according to one preferred embodiment of the present invention.

At step 801, perform low pass filtering according to the coarse bandwidth in time domain.

At step 803, edge-detect the filtered video signal to obtain a difference signal.

At step 805, convert the difference signal to an absolute value signal. At step 807, generate a power spectrum density (PSD) for the absolute value signal.

At step 809, obtain an accurate symbol rate of the video signal according to the power spectrum density, i.e. by detecting a maximum value of the power spectrum density.

The maximum value of the power spectrum density indicates the accurate symbol rate of the signal band. The symbol rate is positive with relation to the signal bandwidth. Ideally, the symbol rate can be a bandwidth from the signal with 3 db decrease. However, a real signal will be seriously distorted in transmission, and the shape of the signal spectrum will also be distorted and be asymmetric correspondingly. Thus, the bandwidth from the signal with 3 db decrease is a coarse bandwidth, which cannot be applied to re-produce the video signal of that channel. On the other hand, theoretically, the accurate symbol rate is an apparent extreme value for the power spectrum density. Therefore, the present invention determines a frequency associated with the maximum value of the power spectrum density as the accurate symbol rate of the video signal for that channel. Simulation is performed and the accurate symbol rate according to the present embodiment is proven to possess an error less than 0.5%.

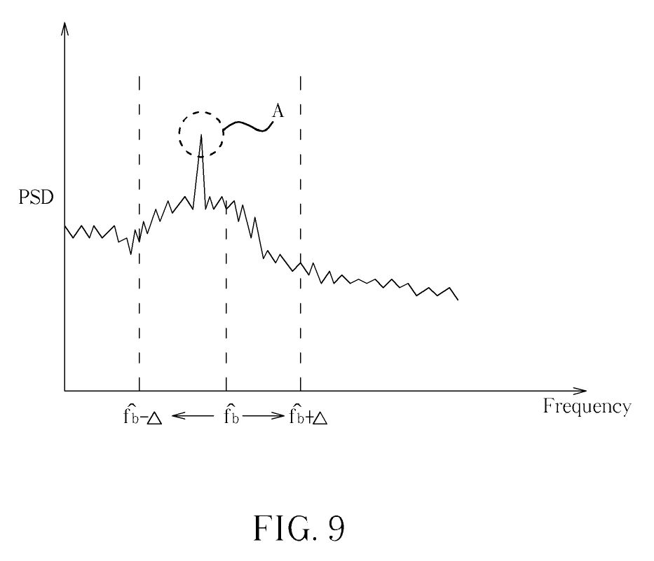

FIG. 9 shows a power spectrum density with reference to operations in FIG. 8. The horizontal axis of FIG. 9 is frequency, and a vertical axis thereof is power spectrum density. A peak value A indicates the accurate symbol rate of the video signal. The accurate symbol rate associates with the coarse bandwidth. The point A of the accurate symbol rate is approximate to the coarse bandwidth. Thus, the accurate symbol rate of the signal band can be rapidly and accurately obtained. For example, assume that the frequency of the horizontal axis ranges from 0 to 50 MHz with 1024 power spectrum density values distributed uniformly. The maximum value point A of the power spectrum density value is found near the coarse bandwidth. For example, in the range of the coarse bandwidth ±Δf, if the point A is at the 475^{th} point, then an accurate symbol rate is determined as:

f_{b}=50 MHz*475/1024=23.193 M

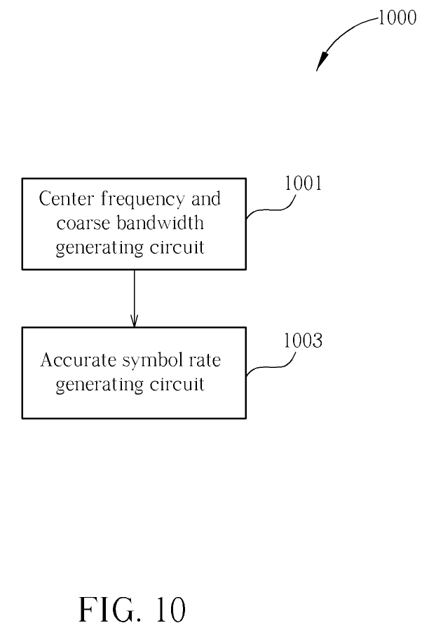

FIG. 10 is a smart channel scan apparatus 1000 according to a preferred embodiment of the present invention, including a center frequency and coarse bandwidth generating circuit 1001 and an accurate symbol rate generating circuit 1003. The center frequency and coarse bandwidth generating circuit 1001 spectrum-analyzes a video signal to generate a center frequency and a coarse bandwidth. The accurate symbol rate generating circuit 1003 receives the video signal and generates an accurate symbol rate according to the coarse bandwidth.

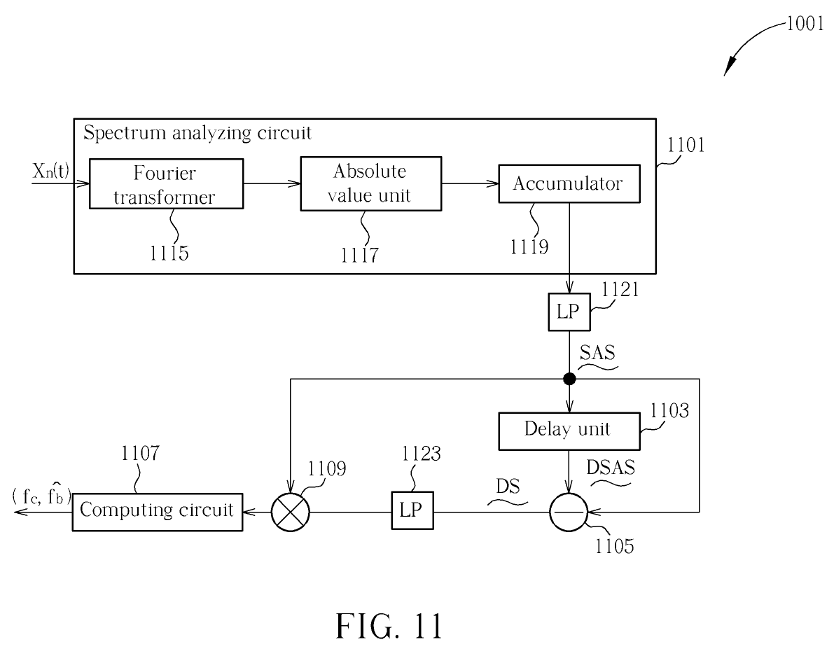

FIG. 11 is a circuit diagram illustrating a center frequency and coarse bandwidth generating circuit 1001 according to a preferred embodiment according to the present invention. The center frequency and coarse bandwidth generating circuit 1001 includes a spectrum analyzing circuit 1101, a delay unit 1103, a subtractor 1105 and a computing circuit 1107. The spectrum analyzing circuit 1101 spectrum-analyzes the video signal to generate a power spectrum density signal SAS. The delay unit 1103, coupled to the spectrum analyzing circuit 1101, delays the power spectrum density signal SAS to generate a delayed power spectrum density signal DSAS. The subtractor 1105, coupled to the delay unit 1103 and the spectrum analyzing circuit 1101, subtracts the delayed power spectrum density signal DSAS from the power spectrum density signal SAS to generate a difference signal DS. For example, the spectrum analyzing circuit 1101 includes a Fourier transformer 1115, an absolute value unit 1117 and an accumulator 1119. The Fourier transformer 1115 performs a Fourier transform on the video signal Xn(t) to obtain a corresponding frequency domain transforming signal F_{Xn}(ω). The absolute value unit 1117 converts the frequency domain transforming signal F_{Xn}(ω) to an absolute value signal |F_{Xn}(ω)|. The accumulator 1119 accumulates the absolute value signal |F_{Xn}(ω)| to generate a power spectrum density signalΣ|F_{Xn}(ω)|.

The computing circuit 1107 determines the center frequency and the coarse bandwidth according to the difference signal DS. The center frequency and coarse bandwidth generating circuit 1001 further comprises a multiplier 1109 for multiplying the difference signal DS and the power spectrum density signal SAS to filter the noise, as shown in FIG. 5. A low-pass filter 1121 can be provided between the spectrum analyzing circuit 1101 and the delay unit 1103 to filter the noise, and a low-pass filter 1123 can be provided between the subtractor 1105 and the multiplier 1109 to filter noise.

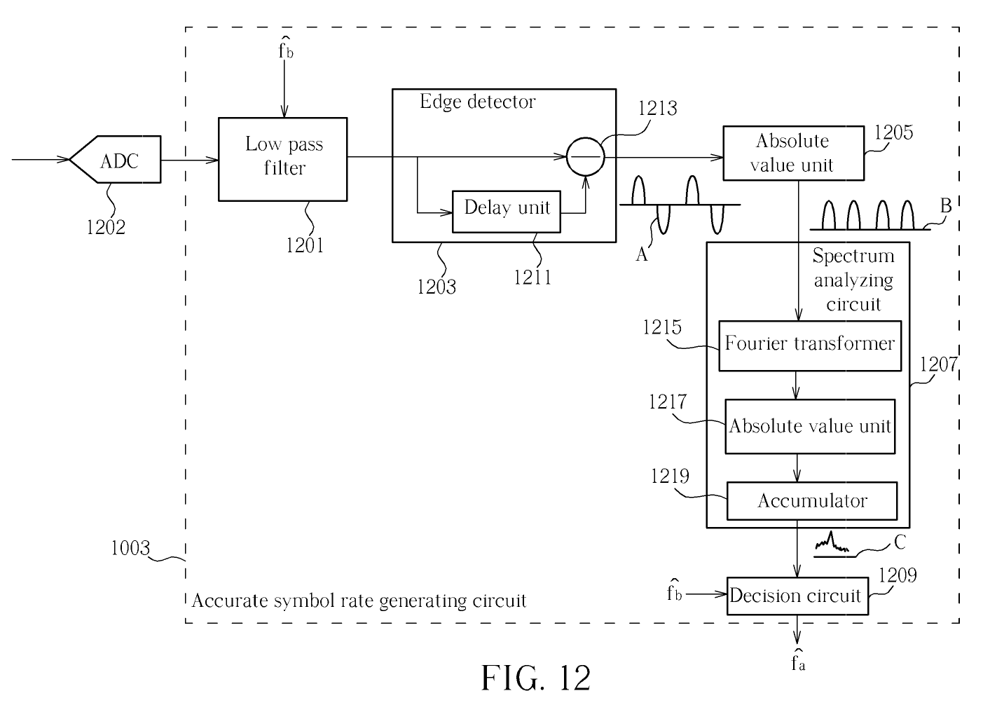

FIG. 12 is an accurate symbol rate generating circuit 1003 according to a preferred embodiment of the present invention, comprising a low pass filter 1201, an edge detector 1203, an absolute value unit 1205, a spectrum analyzing circuit 1207 and a decision circuit 1209. The low pass filter 1201 low-pass filters the video signal according to the coarse bandwidth \hat{f}b. The output from the analog to digital converter 1202 enters the low pass filter 1201. It should be noted that a sampling rate conversion circuit (SRC, not shown) can be further located between the low pass filter 1201 and the analog to digital converter 1202 for converting the video signal to a suitable frequency to increase the resolution.

The edge detector 1203 edge-detects the filtered video signal to obtain a difference signal A. In this embodiment, the edge detector 1203 includes a delay unit 1211 and a subtractor 1213. The absolute value unit 1205 converts the difference signal A to an absolute value signal B. The spectrum analyzing circuit 1207 transforms the absolute value signal from the time domain signal B to the power spectrum density signal C (as shown in FIG. 9). For example, the spectrum analyzing circuit 1207 includes a Fourier transformer 1 215, an absolute value unit 1217 and an accumulator 1219. The Fourier transformer 1215 performs a Fourier transform on a plurality of bands of the video signal to obtain a plurality of first transforming signals. The absolute value unit 1217 computes an absolute value of the transformation result to obtain a second transforming signal. The accumulator 1219 accumulates the second transforming signal to generate a power spectrum density signal C. The decision circuit 1209 determines the accurate symbol rate of a related band according to the power spectrum density signal. Preferably, the decision circuit 1209 detects a maximum value of the power spectrum density signal near the coarse bandwidth \hat{f}b to determine the accurate symbol rate \hat{f}a. Thus, the decision circuit 1209 can be a maximum value searching circuit to output the frequency location of the maximum value.

The center frequency and coarse bandwidth generating circuit 1001 shown in FIG. 11 can share similar circuits with the symbol rate generating circuit 1003 in FIG. 12. Persons skilled in the art can understand that the above embodiments can be implemented in a digital TV, integrated with a DSP (digital signal processing) circuit and a powerful processor. The DSP circuit, for example, can be applied to realize the disclosed embodiment. Alternatively, if the present invention is desired to be implemented in a chip without a DSP circuit, the circuits shown in FIGS. 11 and 12 can be applied and the spectrum analyzing circuit can be shared.

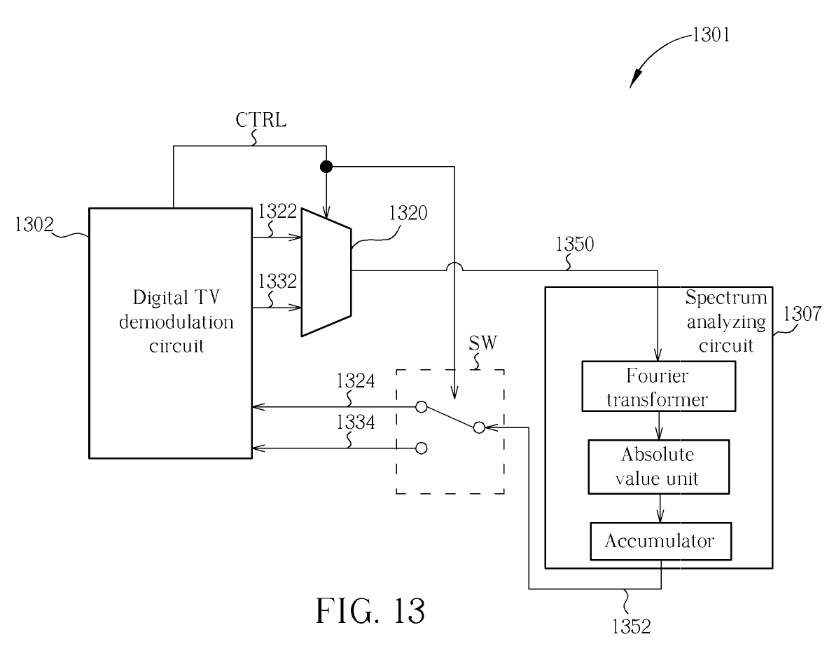

FIG. 13 is a smart channel scan digital TV demodulation apparatus 1301 according to a preferred embodiment of the present invention. The digital TV demodulation apparatus 1301 includes a digital TV demodulation circuit 1302, a multiplexer 1320, a spectrum analyzing circuit 1307 and a switch device SW, to share the spectrum analyzing circuit 1307 and perform a smart channel scan. According to the disclosure of FIGS. 11 and 12, when the digital TV demodulation apparatus 1301 detects the center frequency and the coarse width, the digital TV demodulation circuit 1302 utilizes a path 1322, a multiplexer 1320 and a path 1350 to transmit a time domain signal of the video signal to the spectrum analyzing circuit 1307 for generating a power spectrum density signal. The power spectrum density signal is transmitted to the digital TV demodulation circuit 1302 via the path 1352, the switch device SW and the path 1324. After processing as shown in FIG. 11, the digital TV demodulation circuit 1302 obtains the center frequency and the coarse bandwidth. After that, a digital TV demodulation circuit 1302 processes the video signal in time domain according to the coarse bandwidth, as shown in FIG.12, and then transmits the same to the spectrum analyzing circuit 1307 for generating the power spectrum density signal. Afterwards, the power spectrum density signal is transmitted back to the digital TV demodulation circuit 1302 via the path 1352, the switch device SW and the path 1334 to search a maximum frequency location of the power spectrum density signal near the coarse bandwidth to find the accurate symbol rate. Preferably, the digital TV demodulation circuit 1302 controls the paths selection of the multiplexer 1320 and the switch device SW via a control signal CTRL. Therefore, the spectrum analyzing circuit 1307 can be shared.

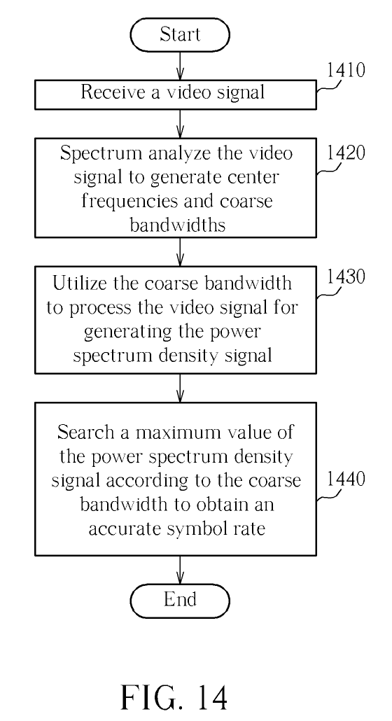

FIG. 14 shows a flow chart of a smart channel scan method according to a preferred embodiment of the present invention. First, in Step 1410, a video signal is received. In Step 1420, spectrum analysis of the video signal generates one or more center frequencies and coarse bandwidths, which associate with the size of a processing window. As shown in FIG. 3, if the processing window is small enough, the processed signal may be just a signal band, and if the processing window is large enough, three signal bands can be processed at one time, that is, three parameters are processed at the same time. In Step 1430, the coarse bandwidth is utilized to process the video signal for generating the power spectrum density signal. In Step 1440, a maximum value of the power spectrum density signal at a proximity of the coarse bandwidth is searched according to the coarse bandwidth to obtain an accurate symbol rate of a signal band according to the center frequency. The center frequency and the accurate symbol rate can identify the digital channel information completely.

Those skilled in the art will readily observe that numerous modifications and alterations of the device and method may be made while retaining the teachings of the invention.

What is claimed is:

1. A smart channel scan method, comprising:
receiving a video signal;
spectrum-analyzing the video signal to generate a center frequency and a coarse bandwidth;
processing the video signal according to the coarse bandwidth to generate a power spectrum density signal; and
obtaining an accurate symbol rate according to the coarse bandwidth and the power spectrum density signal.

2. The smart channel scan method of claim 1, wherein the step of processing the video signal according to the coarse bandwidth comprises:
low-pass filtering the video signal according to the coarse bandwidth;
edge-detecting the filtered video signal to obtain a difference signal;
converting the difference signal to an absolute value signal; and
spectrum-analyzing the absolute value signal to generate the power spectrum density signal.

3. The smart channel scan method of claim 2, wherein the step of obtaining the accurate symbol rate detects a maximum value of the power spectrum density signal to obtain the accurate symbol rate.

4. The smart channel scan method of claim 1, wherein the spectrum analyzing step comprises:
spectrum-analyzing the video signal to generate another power spectrum density signal;
delaying said another power spectrum density signal;
subtracting the delayed another power spectrum density signal from said another power spectrum density signal to obtain a difference signal; and
generating the center frequency according to the difference signal.

5. The smart channel scan method of claim 1, wherein the step of generating the center frequency according to the difference signal averages a first frequency associated with a maximum value and a second frequency associated with a minimum value of the difference signal to obtain the center frequency, wherein the maximum value neighboring the minimum value.

6. The smart channel scan method of claim 4, further comprising multiplying the difference signal and said another power spectrum density signal to filter the noise.

7. The smart channel scan method of claim 4, further comprising subtracting a first frequency associated with a maximum value and a second frequency associated with a minimum value of the difference signal to obtain the coarse bandwidth, wherein the maximum value neighboring the minimum value.

8. The smart channel scan method of claim 4, wherein the coarse bandwidth is determined by detecting a frequency value associated with a predetermined amplitude decrease in said another power spectrum density signal.

9. The smart channel scan method of claim 4, wherein the coarse bandwidth is determined by detecting a frequency value associated with a predetermined energy decrease in said another power spectrum density signal.

10. A smart channel scan apparatus, comprising:
a center frequency and coarse bandwidth generating circuit, for spectrum-analyzing a video signal to generate a center frequency and a coarse bandwidth; and
an accurate symbol rate generating circuit, coupled to the center frequency and coarse bandwidth generating circuit, for receiving the video signal and generating an accurate symbol rate according to the coarse bandwidth.

11. The smart channel scan apparatus of claim 10, wherein the accurate symbol rate generating circuit comprises:
a low pass filter, for low pass filtering the video signal according to the coarse bandwidth;
an edge detector, coupled to the low pass filter, for edge detecting the filtered video signal to obtain a difference signal;
an absolute value unit, coupled to the edge detector, for converting the difference signal to an absolute value signal;
a spectrum analyzing circuit, coupled to the absolute value unit, for spectrum-analyzing the absolute value signal to generate the power spectrum density signal; and
a decision circuit, for determining the accurate symbol rate according to the power spectrum density signal.

12. The smart channel scan apparatus of claim 10, wherein the accurate symbol rate generating circuit generates a power spectrum density signal and detects a maximum value of the power spectrum density signal to determine the accurate symbol rate.

13. The smart channel scan apparatus of claim 10, wherein the center frequency and coarse bandwidth generating circuit generates a difference signal according to the power spectrum density signal, to obtain the center frequency according to the difference signal.

14. The smart channel scan apparatus of claim 13, wherein the center frequency and coarse bandwidth generating circuit averages a first frequency associated with a maximum vale and a second frequency associated with a minimum value of the difference signal to obtain the center frequency, wherein the maximum value neighboring the minimum value.

15. The smart channel scan apparatus of claim 13, wherein the center frequency and coarse bandwidth generating circuit subtracts a first frequency associated with a maximum vale and a second frequency associated with a minimum value of the difference signal to obtain the coarse bandwidth, wherein the maximum value neighboring the minimum value.

16. The smart channel scan apparatus of claim 10, wherein the center frequency and coarse bandwidth generating circuit comprises:
a spectrum analyzing circuit, for spectrum-analyzing the video signal to generate a power spectrum density signal;
a delay unit, coupled to the spectrum analyzing circuit, for delaying the power spectrum density signal to generate a delayed power spectrum density signal;
a subtractor, coupled to the delay unit and the spectrum analyzing circuit, for subtracting the delayed power spectrum density signal from the power spectrum density signal to generate a difference signal; and
a computing circuit, coupled to the subtractor, for determining the center frequency and the coarse bandwidth according to the difference signal.

17. A smart channel scan digital TV demodulation apparatus, comprising:
a digital TV demodulation circuit;
a multiplexer, coupled to the digital TV demodulation circuit;
a spectrum analyzing circuit, coupled to the multiplexer; and
a switch device, coupled to the spectrum analyzing circuit and the digital TV demodulation circuit;
wherein the digital TV demodulation circuit is capable of transmitting a video signal to the spectrum analyzing circuit via the multiplexer to generate a power spectrum density signal that is transmitted back to the digital TV demodulation circuit via the switch device, so that the digital TV demodulation circuit can detect a center frequency and a coarse bandwidth according to the power spectrum density signal.

18. The apparatus of claim 17, wherein the digital TV demodulation circuit generates another power spectrum density signal which is transmitted back to the digital TV demodulation circuit via the switch device, so that the digital TV demodulation circuit determines an accurate symbol rate according to the coarse bandwidth.

19. The apparatus of claim 18, wherein the digital TV demodulation circuit searches a maximum value of the other power spectrum density signal in a predetermined frequency range according to the coarse bandwidth to determine the accurate symbol rate.

20. The apparatus of claim 18, wherein the digital TV demodulation circuit to control the multiplexer and the switch device via a control signal.
